(19) United States
(12) Patent Application Publication
(10) Pub. No.: US 2012/0037286 A1
(43) Pub. Date: Feb. 16, 2012

(54) PROTECTIVE BIKE COVER

(76) Inventors: Chad David WILKINSON, West Palm Beach, FL (US); Lisa Evelyn WILKINSON, West Palm Beach, FL (US)

(21) Appl. No.: 13/208,672

(22) Filed: Aug. 12, 2011

Related U.S. Application Data
(60) Provisional application No. 61/373,427, filed on Aug. 13, 2010.

(51) Int. Cl. B62J 19/00

(52) U.S. Cl. 150/167

(57) ABSTRACT

A bicycle cover and methods of using the same are disclosed. The body of the bicycle cover is two walls made of thin and flexible transparent, weather proof material and includes an opening in the bottom of the cover configured to receive and protect a bicycle. The bicycle cover can include a securing element that secures the bottom cover to further protect the bicycle from the elements. The bicycle cover can include reinforced openings to receive a lock allowing the bicycle to be locked to a rack. The bicycle cover is designed to specifically receive the components of a triathlon bicycle which include aerobars, electronic gear shifters and seat mounted water bottle cages while the bicycle is stored on various styles of racks in the transition area.

### CROSS-REFERENCE TO RELATED APPLICATIONS

This application claims priority to U.S. Provisional Application No. 61/373,427, filed Aug. 13, 2010, the entire contents of which is incorporated herein by reference.

### FIELD OF THE INVENTION

The present invention relates generally to the field of covers, and more particularly to a bicycle cover.

### BACKGROUND

Triathletes and Cyclists, especially those participating in multi-stage races, often leave their bicycles overnight as part of a mandatory pre-race check-in process. Typically, the bicycles are left outside in transition stations along the course. This exposes the bicycles to the environment, leaving them susceptible to damage from heat, moisture and wind. Athletes have the option of leaving their bicycles unprotected or trying to protect them with unconventional covers. Thus, an improved bicycle cover is needed.

### SUMMARY OF THE INVENTION

The invention includes a covering for a bicycle. The covering can include a body comprising first and second walls formed from a flexible, transparent material, with the first and second walls coupled together proximate edges thereof to form a hollow interior and an opening for receiving a bicycle between the first and second walls. The covering can also include a pair of reinforced openings, wherein a first reinforced opening is disposed in the first wall and a second reinforced opening is disposed in the second wall. The first and second reinforced openings can be positioned for receiving a bicycle lock passing through the first and second reinforced openings.

The body can also include a securing element coupled proximate bottom edges of the first and second walls defining the opening. The securing element can be selected from the group consisting of an adjustable cord, an elastic cord, velcro, zippers, buttons, snaps, clasps and toggles.

The top edge of the body can include a generally C-shaped fitted portion. The first and second walls can include a top edge and a bottom edge opposite one another, as well as, a front edge and back edge opposite one another. The generally C-shaped fitted portion can be between the front edge and the back edge. The generally C-shaped fitted portion can include a reinforced portion.

The generally C-shaped fitted portion can be part of a generally S-shaped fitted portion comprising two generally C-shaped fitted portions opening in opposite directions. Each of the generally C-shaped fitted portions forming the S-shaped fitted portion can include a reinforced portion.

In any of the covers described herein, the generally C-shaped fitted portions can be adapted to receive at least one of: the front of a bicycle seat, the front of an aerobar, or a rail.

A method of storing a bicycle for a race is also described. The method can include providing a bicycle cover; covering a bicycle with the bicycle cover; supporting a bicycle to a bicycle rack; and retrieving a bicycle from a bicycle rack. The bicycle cover can be any of the bicycle covers described herein.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a side view of a bicycle cover.

FIG. 2 is a cross-section view of the bicycle cover of FIG. 1 taken along cut line 2-2.

FIG. 3 is a side view a bicycle cover as described herein covering a bicycle with aerobar handlebars.

FIG. 4 is a side view of a bicycle cover as described herein locked to a bicycle rack.

FIG. 5 is a side view of a bicycle cover as described herein locked to a rail.

FIG. 6 is a side view of a bicycle cover as described herein locked with a U-lock.

FIG. 7 is a cross section view of the bicycle cover of FIG. 6 taken along cut line 7-7.

FIG. 8 is a side view of a bicycle cover as described herein having a front and a rear pair of reinforced openings.

FIG. 9 is a cross section view of the bicycle cover of FIG. 8 taken along cut line 9-9.

FIG. 10 is a side view of a bicycle cover as described herein secured by buttons and button holes.

FIG. 11 is a side view of a bicycle cover as described herein secured by hook and loop materials.

FIG. 12 is a side view of a bicycle cover as described herein secured by a zipper.

FIG. 13 is a side view of a bicycle cover as described herein secured by an elastic cord.

FIG. 14 is a side view of a bicycle cover as described herein secured by an adjustable cord.

FIG. 15 is a side view of a bicycle cover as described herein secured by clasps.

FIG. 16 is a side view of a bicycle cover as described herein secured by toggles.

FIG. 17 is a side view of a bicycle cover as described herein secured by clasps and loops.

FIG. 18 is a side view of a bicycle cover as described herein having a reinforced fitted portion.

FIG. 19 is a side view of a bicycle cover as described herein a reinforced fitted portion.

FIG. 20 is a side view of a bicycle cover as described herein.

FIG. 21 is a side view of a bicycle cover as described herein.

FIG. 22 is a side view of a bicycle cover as described herein.

FIG. 23 is a side view of a bicycle cover as described herein covering a bicycle.

FIG. 24 is a side view of a bicycle cover as described herein covering a bicycle.

FIG. 25 is a side view of a bicycle cover as described herein covering a bicycle.

FIG. 26 is a side view of a bicycle cover as described herein that is supported by and locked to a bike rack.

FIG. 27 is a perspective view of a bicycle cover as described herein coupled to a tube from a bicycle frame.

### DETAILED DESCRIPTION

As shown in the FIGS., a bicycle cover 10 with a body 12 is described. The body 12 may be configured to receive and protect a bicycle (A), e.g., during storage prior to or during a race.

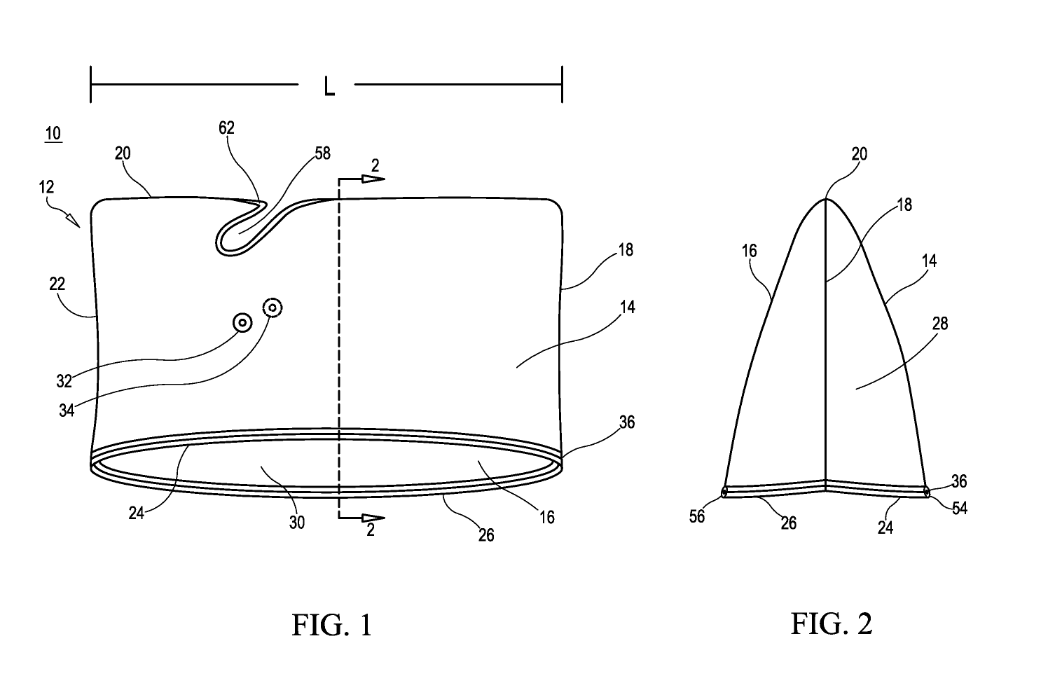

As shown in FIGS. 1-2, the body 12 may be formed from first and second walls 14, 16 of a flexible, transparent material. The first and second walls 14, 16 of the body 12 can include any flexible, transparent or semi-transparent material suitable for a bicycle cover. The first and second walls 14, 16 are coupled together proximate edges 18, 20, 22 thereof to form a hollow interior 28 and an opening 30 for receiving a bicycle (A) between the first and second walls 14, 16.

The edges 18, 20, 22 of the first and second walls 14, 16 can be coupled together using any appropriate technique including, but not limited to, thermal bonding techniques, ultrasonic bonding techniques, sewing techniques, binding techniques and combinations thereof. In addition, the edges can be continuous and defined only by the folding of the bicycle cover itself.

The first and second walls 14, 16 can have a top edge 20. In some instances, the first and second walls may be formed from the same sheet of material folded at the top edge 20. Each of the first and second walls 14, 16 can have a bottom edge 24, 26, respectively, where the top and bottom edges can be opposite one another. Each wall 14, 16 and the body 12 can have a front edge 18 and a back edge 22, where the front and back edges 18, 22 can be opposite one another.

The body 12 can be substantially rectangular in shape. As used herein, the term “substantially rectangular” with respect to the body 12 of the bicycle cover 10 is used to describe a shape approximating a rectangle with or without minor deviations such as those shown in the FIGS. for the fitted portions.

Exemplary flexible transparent or semi-transparent materials include, but are not limited to, films and non-woven materials. Exemplary flexible transparent or semi-transparent materials can be formed from a plastic, which can include, but is not limited to, polypropylene, polyethylene, polyester, vinyl, polyurathane, co-polymers thereof and mixtures thereof. The flexible transparent or semi-transparent materials can be add water resistant, weather proof, or both. As used herein the term “plastic” is used to describe a polymer with or without additives and includes both thermoplastics and thermosets.

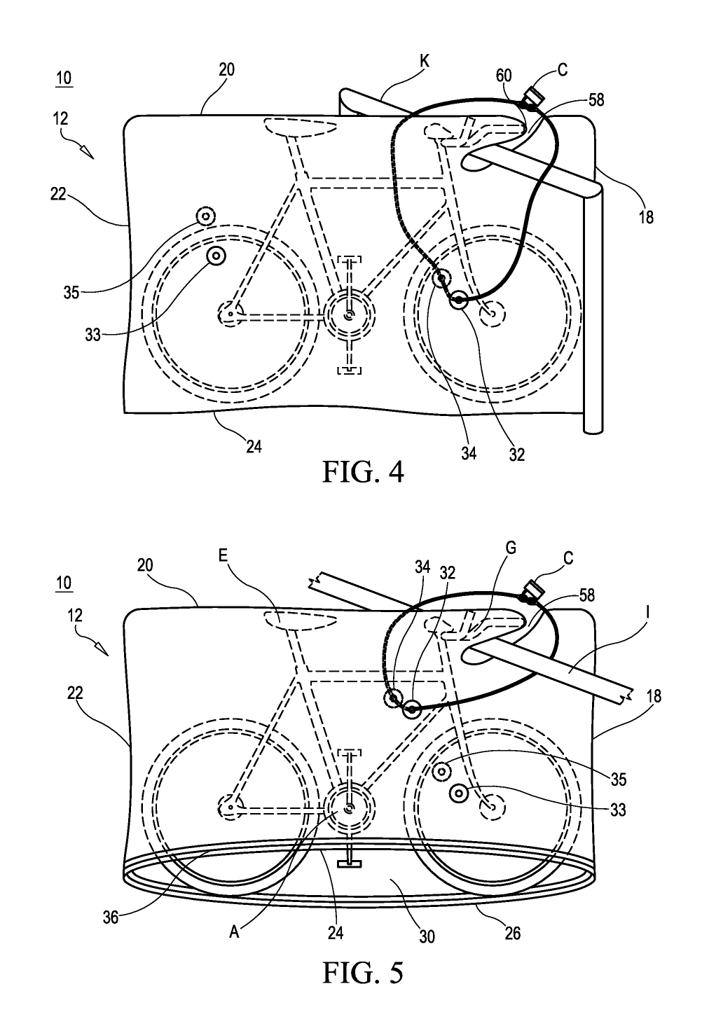

As shown in FIG. 1, the body 12 can include a pair of reinforced openings 32, 34 where the first reinforced opening 32 can be disposed in the first wall 14 and the second reinforced opening 34 can be disposed in the second wall 16. In one exemplary arrangement, as shown in FIG. 1 the reinforced openings 32, 34 can be grommets made of a material suitable for a grommet, such as metal or plastic. The reinforced region of the reinforced openings (32-35, 37, 39, 41 and 43) can be cast as part of the first or second walls 14, 16, or can be added to the first or second wall 14, 16. As shown in FIGS. 4-5, the first and second reinforced openings 32, 34 can be positioned for receiving a bicycle lock (C) passing through the first and second reinforced openings 32, 34.

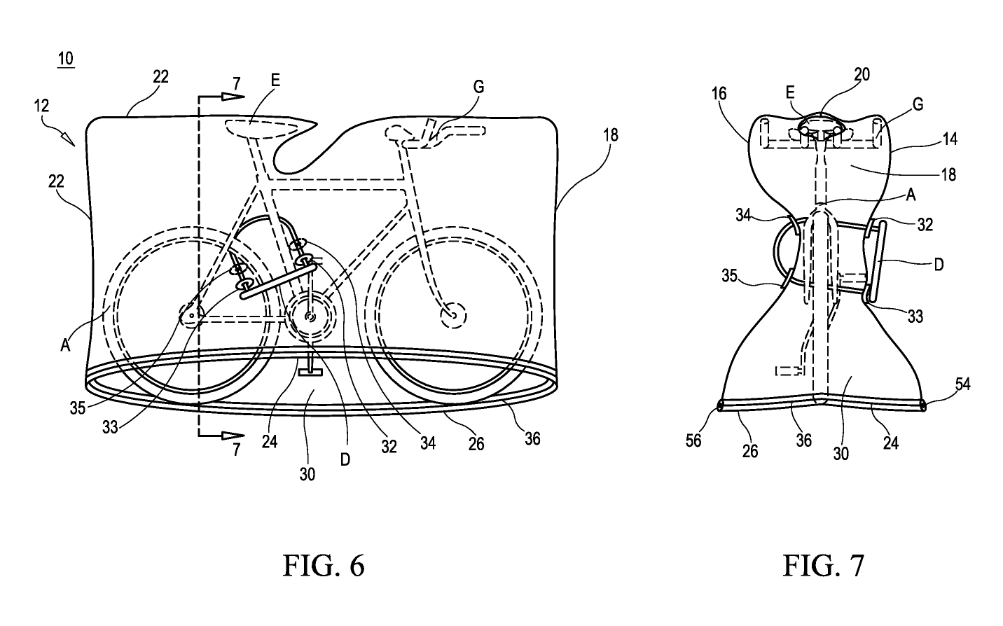

As shown in FIGS. 6-9, the bicycle cover 10 can be adapted to be compatible with a variety of bicycle locks (C). Bicycle locks of interest include, but are not limited to, U-locks, chain locks, and cable locks. As will be understood, the position and number of pairs of reinforced openings can vary to accommodate a variety of bicycle locks (C).

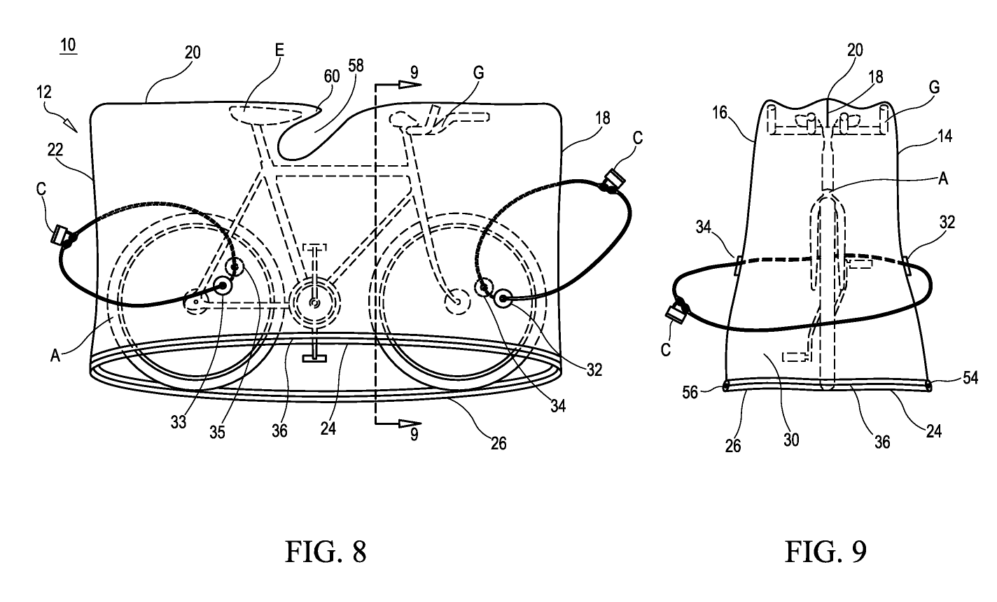

As shown in FIGS. 6-7, two pairs of reinforced openings can be located proximate to each other in order to receive a U-shaped bicycle lock (C) passing through a first pair of reinforced openings 32, 34, the frame of the bicycle (A) and a second pair of reinforced openings 33, 35. As shown in FIGS. 8-9, one pair of reinforced openings 32, 34 can be located proximate the front edge 18 of the cover 10 in order to secure a front portion of the bicycle disposed therein (e.g., the front of the bicycle frame, a front wheel or both) and a second pair of reinforced openings 33, 35 can be located proximate the back edge 22 in order to secure a back portion of the bicycle disposed therein (e.g., the back of the bicycle frame, a back wheel, or both). Each pair of reinforced openings 32-35 can be positioned for receiving a bicycle lock (C) passing through the first reinforced opening 32 or 33, the frame or a wheel of the bicycle (B), and the second reinforced opening 34 or 35. As shown in FIGS. 6-7, the bicycle lock can pass through a frame or wheel between a first set of reinforced openings, and then a wheel or frame between a second set of reinforced openings. Such reinforced openings for a U-lock can be positioned on the body in order to secure the frame-front wheel, frame-rear wheel, or both (i.e., four sets of reinforced openings).

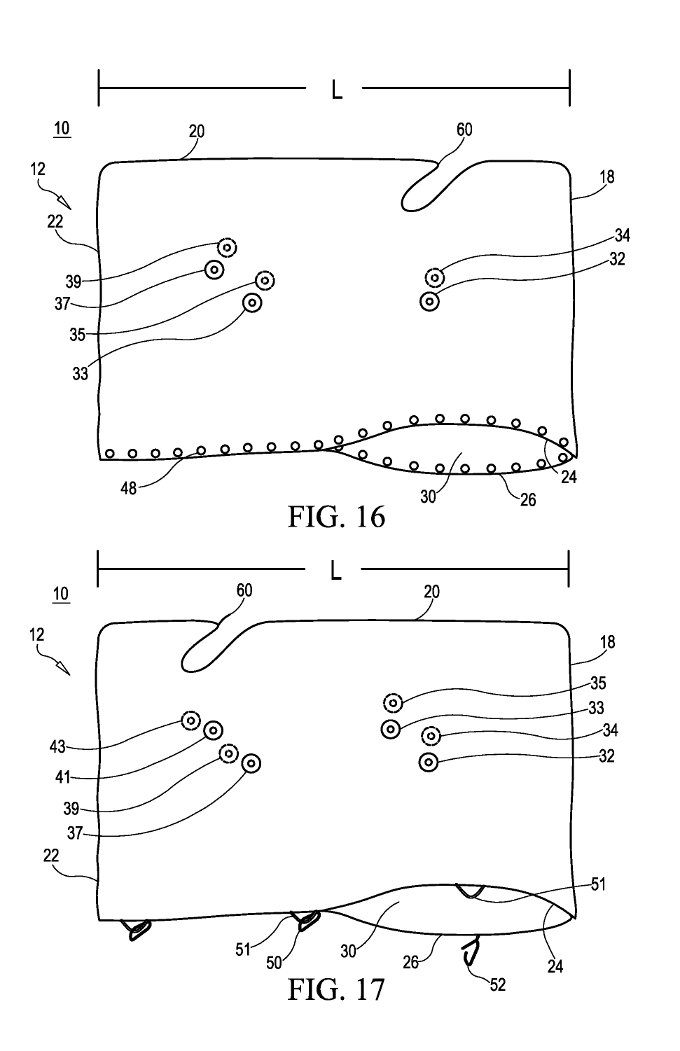

As shown in FIG. 16, one pair of reinforced openings 32, 34 can be located proximate the front edge 18 of the cover 10 in order to secure a front portion of the bicycle disposed therein (e.g., the front of the bicycle frame) and second and third pairs of reinforced openings 33 & 35 and 37 & 39 can be located proximate the back edge 22 in order to secure a back bicycle disposed therein in a manner adapted to secure both the frame and the front wheel. As shown in FIG. 17, two pairs of reinforced openings 32 & 34 and 33 & 25 can be located proximate the front edge 18 of the cover 10 in order to secure a bicycle disposed therein in a manner adapted to secure both the frame and the front wheel, while third and fourth pairs of reinforced openings 37 & 39 and 41 & 43 can be located proximate the back edge 22 in order to secure a bicycle disposed therein in a manner adapted to secure both the frame and the rear wheel.

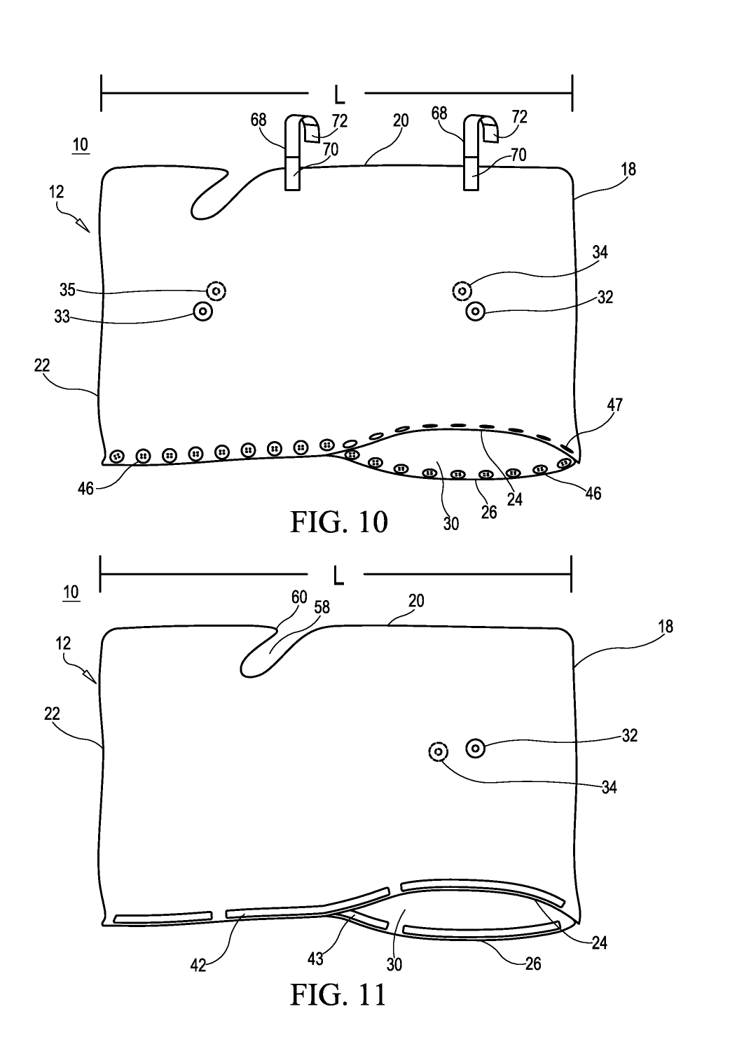

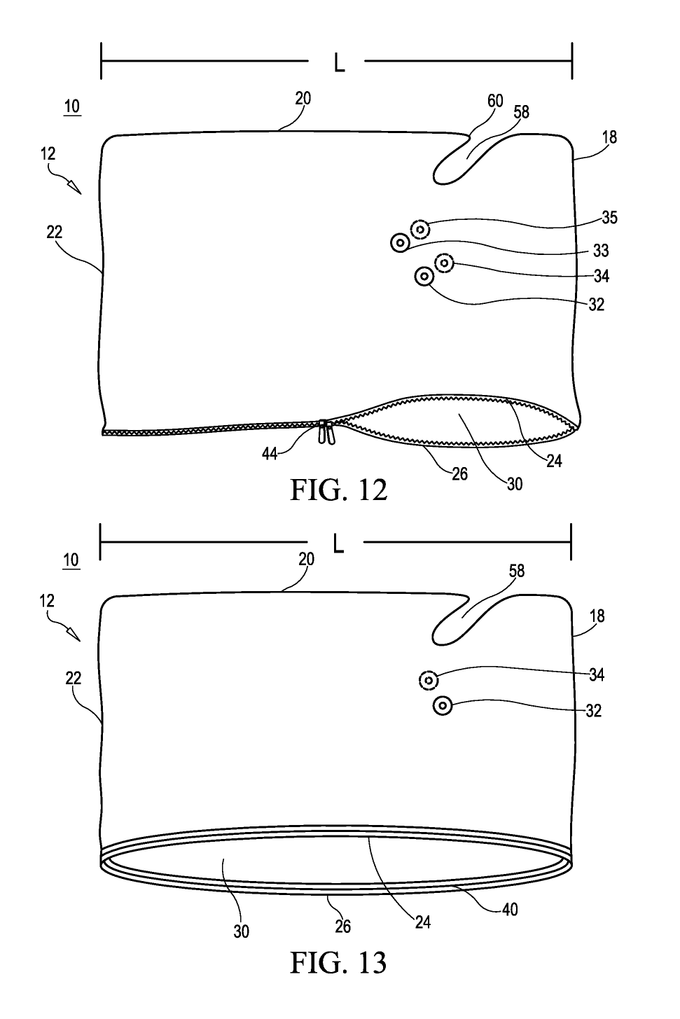

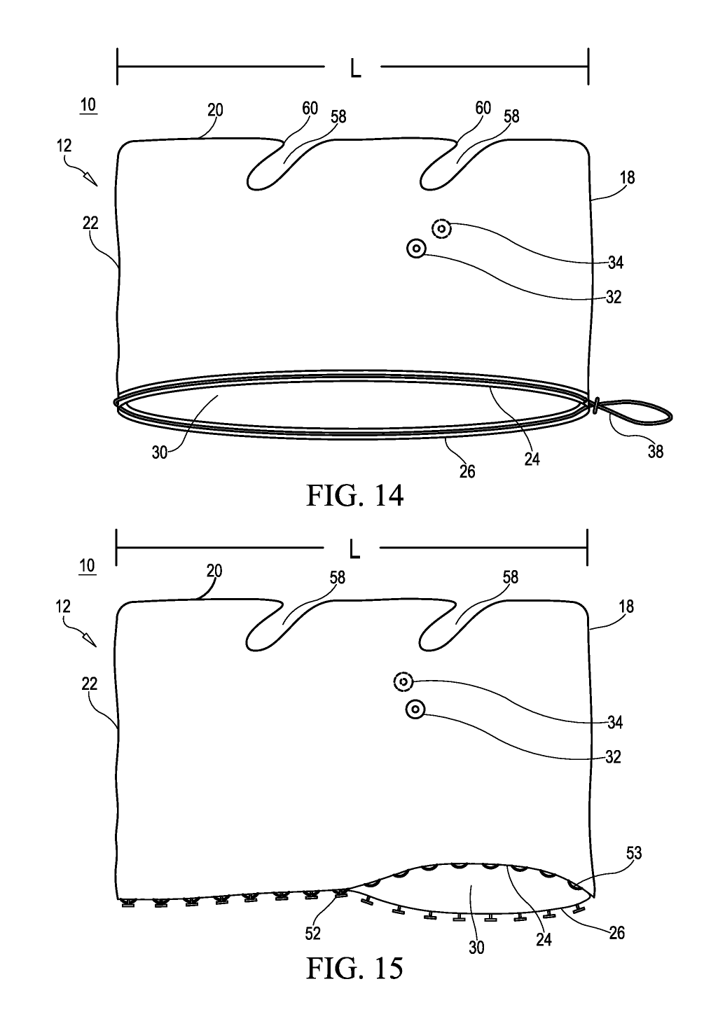

As shown in FIGS. 10-17, the body 12 can include a securing element 36 coupled proximate to the bottom edges 24, 26 of the first and second walls 14, 16, which define the opening 30. The securing element 36 can be one or more adjustable cords 38 (FIG. 14), elastic cords 40 (FIG. 13), hook and loop materials 42 (FIG. 11), zippers 44 (FIG. 12), buttons 46 and button holes 47 (FIG. 10), snaps 48 (FIG. 16), clasps 50 and loop 51 (FIG. 17), or toggles 52 and loops 53 (FIG. 15).

As shown in FIGS. 1-2, 6-9 and 13-14, where the securing element 36 is a cord, the securing element 36 can be disposed within sleeves 54, 56 proximate bottom edges 24, 26 of the body 12. As shown in FIGS. 10-12, and 15-17, the securing element 36 can be attached directly to the body 12 proximate to the bottom edges 24, 26.

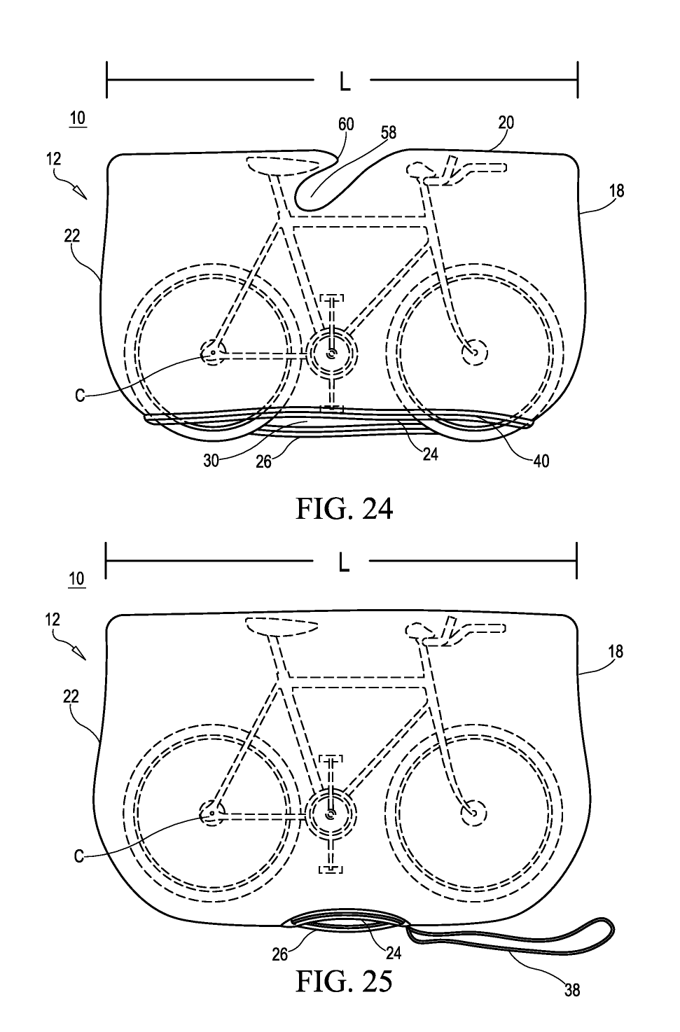

As shown in FIG. 23, the securing element 36 can be an adjustable cord 38 and can substantially close the opening 30. As shown in FIG. 24, the securing element 36 can be an elastic cord 40 and close the opening around the wheels of the bicycle (A). As shown in FIG. 25, in yet another embodiment, the securing element 36 can be an adjustable cord 38 and can completely close the opening 30.

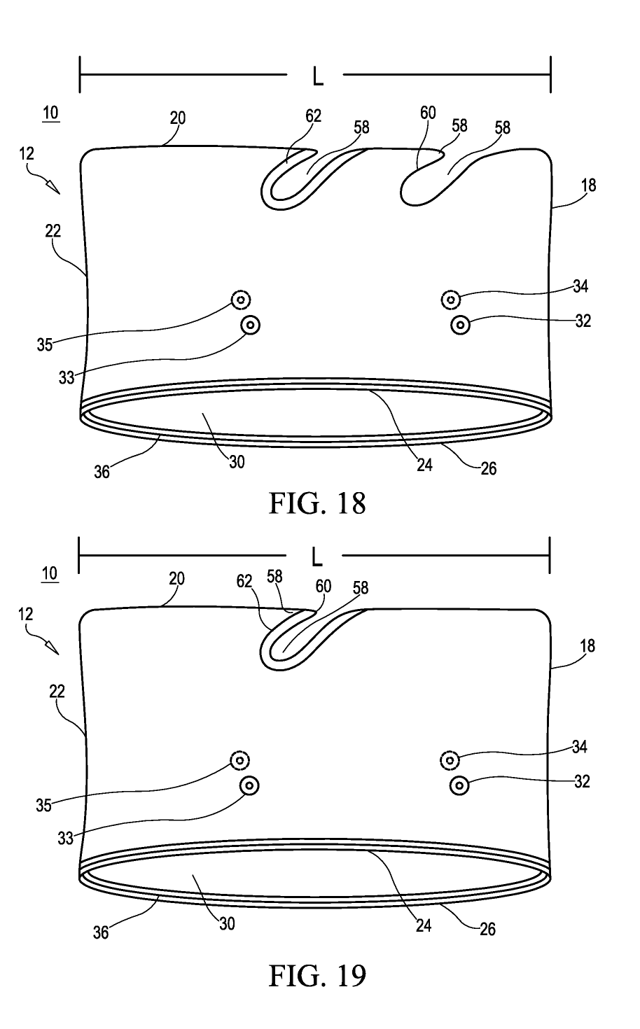

As shown in FIGS. 18-19, the top edge 20 of the body 12 can include one or more generally C-shaped fitted portions 58. The generally C-shaped fitted portion 58 can be part of a generally S-shaped fitted portion 60.

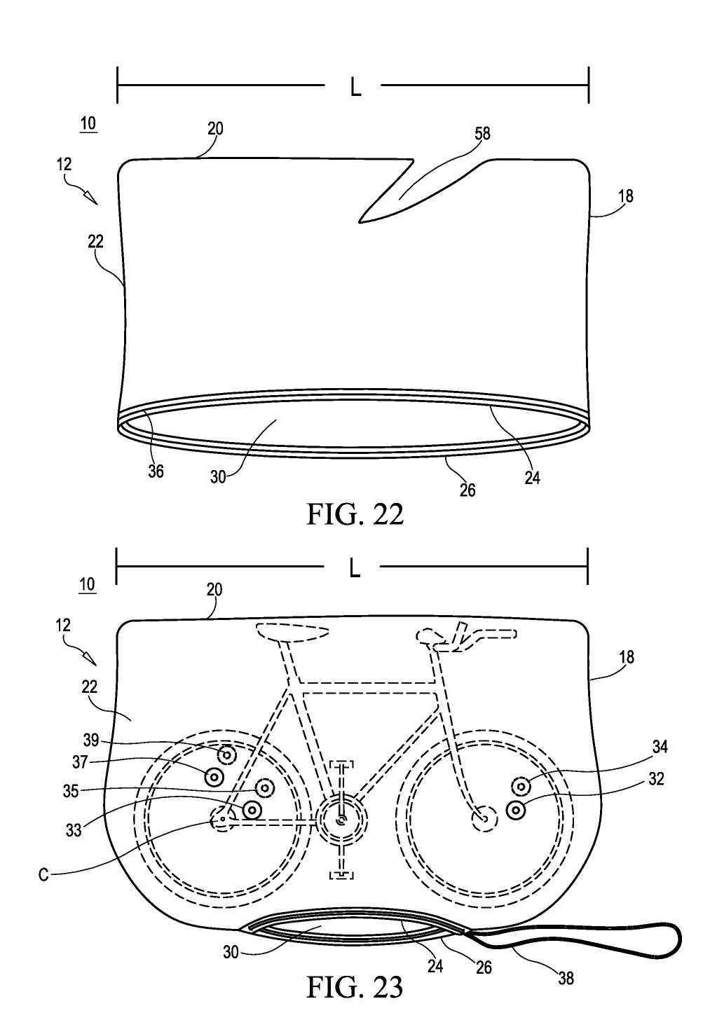

As used herein, the term “generally C-shaped” with respect to a portion of the body 12 refers to a concave shape that includes having the shape of the letter “C”, the letter “V” and modifications thereof, including, but not limited to rotation thereof. As shown in FIGS. 21-22, the generally C-shaped fitted portion may be a backwards “C” (FIG. 21) or a “V” on its side (FIG. 22).

As used herein, the term “generally S-shaped” with respect to a region of the body 12 refers to two concave regions, e.g., two generally C-shaped regions adjacent one another and opening in opposite directions. In general, two C-shaped portions will necessarily be part of an generally S-shaped portion.

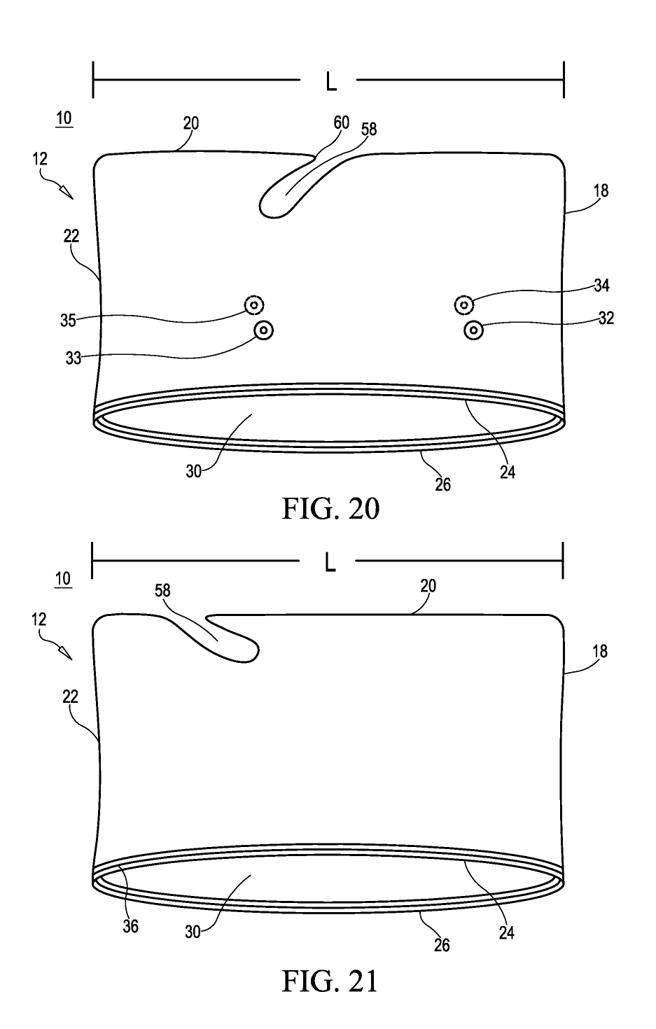

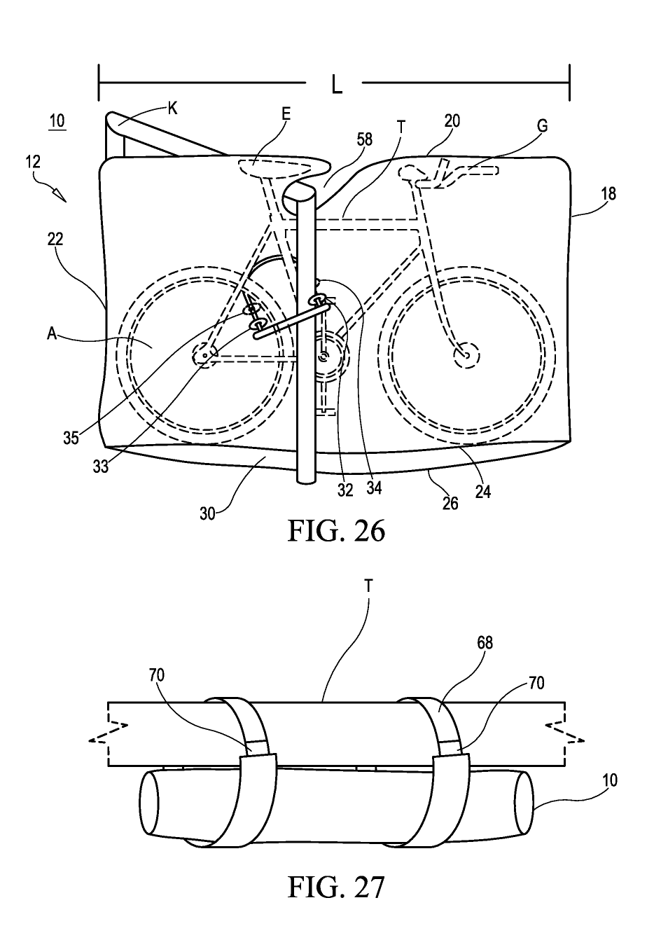

As shown in FIGS. 1, 3-6, 8, 10-22, 24 and 26, the generally C-shaped fitted portion 58 or generally S-shaped fitted portion 60 can be located along the top edge 20, between the front edge 18 and the back edge 22. As shown in FIGS. 4-5, the generally C-shaped fitted portion 58 or generally S-shaped fitted portion 60 can be proximate the front edge 18. As shown in FIGS. 10 and 17, the generally C-shaped fitted portion 58 or generally S-shaped fitted portion 60 can be proximate the back edge 22.

The generally C-shaped fitted portion 58 or generally S-shaped fitted portion 60 can be located along the top edge 20, and may be no closer than 5% of the total length (L) of the cover 10 to the front or back edges 18, 22 of the body 12. Similarly, the generally C-shaped fitted portion 58 or generally S-shaped fitted portion 60 can be located along the top edge 20, and may be no closer than 10% of the total length (L) of the cover 10 to the front or back edges 18, 22 of the body 12, or no closer than 15% of the total length (L) of the cover 10 to the front or back edges 18, 22 of the body 12, or no closer than 20% of the total length (L) of the cover 10 to the front or back edges 18, 22 of the body 12. The generally C-shaped fitted portion 58 or generally S-shaped fitted portion 60 can also be located along the top edge 20, and may be located in the middle 50% of the total length of the cover 10 between the front edge 18 and the back edge 22.

As shown in FIGS. 18-19, the generally C-shaped fitted portion 58 or generally S-shaped fitted portion 60 can include a reinforced portion 62. For example, the reinforced portion 62 can reinforce the entire generally C-shaped fitted portion 58 or generally S-shaped fitted portion 60. In other embodiments the reinforced portion 62 can reinforce part of the generally C-shaped fitted portion 58 or generally S-shaped fitted portion 60. The reinforced portion 62 can be formed of a metal, a plastic, or any other suitable reinforcing material. The reinforcing portion 62 can define an external edge of the generally C-shaped fitted portion 58 or generally S-shaped fitted portion 60.

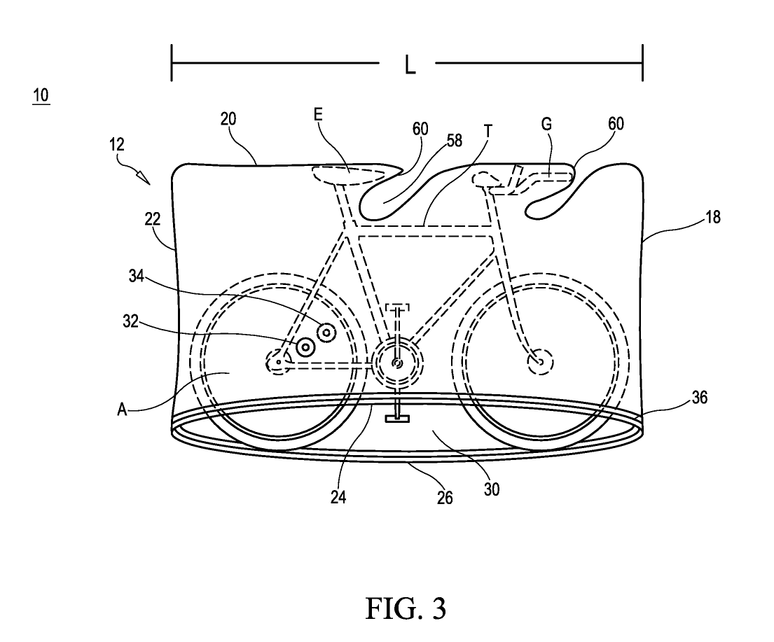

As shown in FIGS. 3-5, the generally C-shaped fitted portion 58 or generally S-shaped fitted portion 60 can be adapted to receive various objects. For example, as shown in FIG. 3, the generally C-shaped fitted portion 58 or generally S-shaped fitted portion 60 can be adapted to receive the front of a bicycle seat (E) by sliding the generally C-shaped fitted portion 58 or generally S-shaped fitted portion 60 of the bicycle cover 10 over a bicycle seat (E). As shown in FIG. 3, the generally C-shaped fitted portion 58 or generally S-shaped fitted portion 60 can be adapted to receive the front of an aero bar (G) of a bicycle (A) by sliding the generally C-shaped fitted portion 58 or generally S-shaped fitted portion 60 of the bicycle cover 10 over an aero bar (G).

As shown in FIG. 5, the generally S-shaped fitted portion 60 can be adapted so that a first C-shaped portion can receive a pipe (I) external to the cover 10, while the second C-shaped portion can be adapted to receive an aerobar of the bicycle covered by the cover 10. Similarly, as shown in FIG. 4, the generally S-shaped fitted portion 60 can include a first C-shaped portion adapted to receive a rail external to the cover 10, while the second C-shaped portion can be adapted to receive the front of a bicycle seat (E), e.g., the nose of the bicycle seat, disposed within the cover 10.

As used herein, the term “pipe” refers to any generally cylindrical structure that can serve as an external body to secure a bicycle to or rest a bicycle on or against. As used herein the term “bicycle rack” refers to any structure, framework or object capable of holding or parking a bicycle.

Methods of using the cover 10 described herein are also disclosed. The cover 10 can be used for storing a bicycle (A). The method of storing a bicycle (A) can include providing the bicycle cover 10 as described herein, covering a bicycle (A) with the bicycle cover 10, supporting the bicycle (A) to a bicycle rack (K), or other suitable structure for supporting a bicycle, and then retrieving the bicycle (A) from the bicycle rack (K). The supporting can also include fastening or locking the bicycle (A) and the cover 10 to the rack by passing a lock through one or more pairs of reinforced openings. The supporting can also include engaging an externally concave portion of a C-shaped or S-shaped fitted portion with a rail, rack or pipe, where the rail, rack or pipe resting beneath the nose of a seat or a front of an aerobar of a bicycle disposed within the cover 10.

The cover 10 can be also used for storing a bicycle (A) prior to a race. The method of storing a bicycle (A) prior to a race can include providing the bicycle cover 10 described herein, covering a bicycle (A) with the bicycle cover 10, supporting the bicycle (A) to a pipe (I) or a bicycle rack (K), and retrieving the bicycle (A) from the pipe (I) or bicycle rack (K).

The method can also include embodiments where the cover 10 is used for storing a bicycle (A) for a multistage race, e.g., a biathalon or triathalon. The method of storing a bicycle (A) for a multistage race can include providing the bicycle cover 10 described herein, covering a bicycle (A) with the bicycle cover 10, supporting the bicycle (A) with a structure, such as a pipe (I) or a bicycle rack (K), and retrieving the bicycle (A) from the pipe (I) or bicycle rack (K).

The method can also include, covering a bicycle (A) with the cover 10 at a transition zone at a biathlon, triathlon or other multistage race. The method of storing a bicycle (A) at the transition zone of a multistage race can include providing the bicycle cover 10 described herein, covering a bicycle (A) with the bicycle cover 10, supporting the bicycle (A) with a rack at a transition station, and retrieving the bicycle (A) from the pipe (I) or bicycle rack (K) during the race. The transparency of the cover 10 and the unique shape of the fitted portions are of particular importance. For example, the S-shaped portion can be used to rest the triathlon bicycle on a simple transition station rack. In addition, the fact the cover 10 is transparent allows the user to easily identify the user's covered bicycle during the chaos at the transition zone where hundreds or even thousands of athletes may be searching for their bicycles simultaneously.

The method can also include a bicycle (A) being covered with the bicycle cover 10. The opening 30 of the cover 10 can be secured around the bicycle by a securing element 36 coupled to the bottom edges 24, 26 of the first and second walls 14, 16 defining the opening. As shown in FIGS. 10-17, exemplary securing elements can include adjustable cords 38, elastic cords 40, velcro 42, zippers 44, buttons 46, snaps 48, clasps 50, toggles 52 or other appropriate fasteners.

As shown in FIGS. 4-5 and 26, the covered bicycle (A) can be locked to a bicycle rack (K), pipe (I), or similar structure by passing a bicycle lock (C) through the reinforced openings 32, 34 and locking the covered bicycle (A) to the bicycle rack (K). Similarly, reinforcement of the C-shaped and/or S-shaped fitted portions allows the cover 10 to be reused without tearing of the cover along the top edge 20. The bicycle cover 10 can protect the bicycle (A) from environmental conditions, such as heat, moisture and wind.

In another exemplary storage method, the body 12 of the bicycle cover 10 can include a generally C-shaped fitted portion 58 or a generally S-shaped fitted portion 60. As shown in FIG. 3, the bicycle (A) can be covered with the body 12 of bicycle cover so that the generally C-shaped fitted portion 58, or generally S-shaped fitted portion 60 can receive a front portion of the bicycle seat (E), or aerobar (G). The opening 30 of the cover 10 can be closed around the bicycle (A) using a securing element 36. Due to the unique configuration of the fitted portions, the covered bicycle (A) can be easily supported on a rail or bicycle rack under the bicycle seat (E). The covered bicycle (A) can be secured to a bicycle rack, pipe, or similar structure by passing a bicycle lock (C) through the reinforced openings 32, 34 and locking the covered bicycle (A) to the bicycle rack (K) or pipe (I). The transparent material of the body 12 can allow the covered bicycle (A) to be easily identified when left with other covered bicycles at a race, triathlon, duathlon or similar multistage race.

As shown in FIG. 10, the bicycle cover 10 can also include one or more fastening straps 68. The fastening straps 68 can include fastening portions at each end of the fastening straps. For example, the fastening straps 68 can include a hook portion 70, 72 and a loop portion 72, 70, The fastening straps 68 can be used to maintain the bicycle cover 10 in a rolled configuration for storage. In addition, as shown in FIG. 27, the fastening straps 68 can be used to fasten the bicycle cover 10 to a tube (T) of a bicycle frame after the bicycle cover is removed at the transition zone.

The foregoing is provided in the context of possible applications for a bicycle cover according to various aspects of the invention. While the above description and figures are made in the context of specific bicycle covers and methods, it will be understood that the apparatus according to aspects of the invention can be readily applied to variants of the bicycle covers. In fact, any combination of bicycle cover features described herein are intended to be used together in any possible combination. Thus, it will of course be understood that the invention is not limited to the specific details described herein, which are given by way of example only, and that various modifications and alterations will be apparent to those skilled in the art and may be made without departing from the scope or spirit of this invention.

What is claimed is:

1. A covering for a bicycle, comprising:
a body comprising first and second walls formed from a flexible, transparent material, said first and second walls coupled together proximate edges thereof to form a hollow interior and an opening for receiving a bicycle between said first and second walls;
a pair of reinforced openings, wherein a first reinforced opening is disposed in said first wall and a second reinforced opening is disposed in said second wall, wherein said first and second reinforced openings are positioned for receiving a bicycle lock passing through said first and second reinforced opening.

2. The covering according to claim 1, wherein said body further comprises a securing element coupled proximate bottom edges of said first and second walls defining said opening.

3. The covering according to claim 2, wherein said securing element is selected from the group consisting of an adjustable cord, an elastic cord, velcro, zippers, buttons, snaps, clasps and toggles.

4. The covering according to claim 1, wherein a top edge of said body comprises a generally C-shaped fitted portion.

5. The covering according to claim 4, wherein said first and second walls comprise a top edge and a bottom edge opposite one another, and a front edge and back edge opposite one another,
wherein said generally C-shaped fitted portion is between said front edge and said back edge.

6. The covering according to claim 4, wherein said generally C-shaped fitted portion is proximate to said front edge.

7. The covering according to claim 4, wherein said generally C-shaped fitted portion is proximate to said back edge.

8. The covering according to claim 4, wherein said generally C-shaped fitted portion comprises a reinforced portion.

9. The covering according to claim 4, wherein said generally C-shaped fitted portion is part of a generally S-shaped fitted portion comprising two generally c-shaped fitted portions facing in opposite directions.

10. The covering according to claim 9, wherein each of said generally C-shaped fitted portions comprises a reinforced portion.

11. The covering according to claim 4, wherein the generally C-shaped fitted portion is adapted to receive a front of a bicycle seat.

12. The covering according to claim 4, wherein the generally C-shaped fitted portion is adapted to receive a front of an aero bar.

13. The covering according to claim 4, wherein the generally C-shaped fitted portion is adapted to receive a rod.

14. A covering for a bicycle, comprising:
a body comprising first and second walls formed from a flexible, transparent material, said first and second walls coupled together proximate edges thereof to form a hollow interior and an opening for receiving a bicycle between said first and second walls; and
wherein a top edge of said body comprises a generally C-shaped fitted portion.

15. The covering according to claim 14, wherein said first and second walls comprise a top edge and a bottom edge opposite one another, and a front edge and back edge opposite one another,
wherein said generally C-shaped fitted portion is between said front edge and said back edge.

16. The covering according to claim 15, wherein said generally C-shaped fitted portion is proximate to said back edge.

17. A method of storing a bicycle for a race, comprising:
providing a bicycle cover;
covering a bicycle with said bicycle cover;
supporting a bicycle to a bicycle rack; and
retrieving a bicycle from a bicycle rack, wherein said bicycle cover comprises:
a body comprising first and second walls formed from a flexible, transparent material, said first and second walls coupled together proximate edges thereof to form a hollow interior and an opening for receiving a bicycle between said first and second walls.

18. The method of storing a bicycle for a race according to claim 17, wherein a top edge of said body comprises a generally C-shaped fitted portion.

19. The method of storing a bicycle for a race according to claim 17, wherein said body is adapted for receiving a seat or an aerobar of a triathlon bicycle.

20. The method of storing a bicycle for a race according to claim 17, wherein said covering and retrieving steps occur at a transition zone.
